(19) United States
(12) Patent Application Publication
(10) Pub. No.: US 2007/0268512 A1
(43) Pub. Date: Nov. 22, 2007

(54) Printing control apparatus, authenticated printing system, and recording medium storing printing control program

(75) Inventor: Masahito Sakakibara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/605,291

(22) Filed: Nov. 29, 2006

(30) Foreign Application Priority Data
May 19, 2006 (JP) 2006-140383

(51) Int. Cl. G06K 15/00

(52) U.S. Cl. 358/1.14

(57) ABSTRACT

A printing control apparatus, which includes a storage section that stores a printing job; a transfer section that transfers the stored printing to a printing apparatus according to a transfer request based on an authentication and changes a state of the printing job from a printing suspended state to a printing instructed state; a monitoring section that monitors a printing process in the printing apparatus for the printing job transferred by the transfer section; and a printing control section that, in case where the monitoring section detects that the printing process of the transferred printing job in the printing apparatus has been interrupted, instructs the printing apparatus to halt the printing processing, and causes the state of the printing job to be changed from the printing instructed state to the printing suspended state.

### BACKGROUND

1. Technical Field

The present invention relates to a printing control apparatus, an authenticated printing system, and a recording medium storing a printing control program.

2. Related Art

In recent years, with the OA (Office Automation) being progressed, offices (business enterprises and government and municipal offices), schools, and the like, have constructed a printing environment in which a plurality of computers (hereinbelow called client terminals) can use one or more printing apparatus (for example, printer) connected to the network in common with one another.

In such an printing environment, there is a possibility that a third person takes away or steals a glance at the printed matter outputted, thus especially when confidential information, or the like, which must not be exposed to the view of a third person, is to be printed, there has been the need for taking some measure against information leakage.

As a method for preventing such information leakage, the so-called authenticated printing system in which the printing is once suspended, and at the time of outputting, the user inputs the password into the printer, applies the IC card thereto, or otherwise does, thereby carrying out user authentication for specifying the printing job before starting the printing which is performed with the user attending the machine has been proposed.

With this authenticated printing system, at the time when the implementation of the job output has caused the printing job to be transferred from the print server to the printer, the printing job on the print server side is cancelled, and the control thereafter is passed to the printer side.

However, even if such a measure is taken, in case where there occurs a trouble which results in the printing being interrupted in the course of the printing process, and thereafter the trouble is eliminated, the printer will resume the printing process in order to assure the output of the printing job which has been instructed for printing, thus in case where the user who has instructed the printing has left the machine, and thereafter the trouble has been eliminated, the printing process will be resumed, which might be led to such a problem as wrongly left prints, information leakage, or the like.

Then, to eliminate the possibility of occurrence of such a problem, a scheme which, in case where there occurs a trouble which interrupts the printing process in the course of printing, and thereafter the trouble is eliminated, requests authentication again at the time when the printing is to be resumed is proposed. In addition, another scheme which, in case where the output is not implemented even after the printing has been instructed and then a prescribed period of time has elapsed, inhibits the printing is proposed.

### SUMMARY

An aspect of the present invention provides a printing control apparatus, which includes a storage section that stores a printing job; a transfer section that transfers the stored printing job to a printing apparatus according to a transfer request based on an authentication and changes a state of the printing job from a printing suspended state to a printing instructed state; a monitoring section that monitors a printing process in the printing apparatus for the printing job transferred by the transfer section; and a printing control section that, in case where the monitoring section detects that the printing process of the transferred printing job in the printing apparatus has been interrupted, instructs the printing apparatus to halt the printing processing, and causes the state of the printing job to be changed from the printing instructed state to the printing suspended state.

### BRIEF DESCRIPTION OF THE DRAWINGS

Embodiments of the present invention will be described in detail based on the following figures, wherein:

FIG. 1 is a drawing illustrating one example of the entire configuration of the authenticated printing system pertaining to the present invention;

FIG. 2 is a drawing illustrating a part of the functional configuration of the print server 20;

FIG. 3 is a flowchart illustrating the operation of the printing control process in this authenticated printing system as shown in FIG. 1 and FIG. 2;

FIG. 4 is a drawing illustrating one example of the modification pertaining to the present invention; and

FIG. 5 is a drawing illustrating the flow of the general printing process in the authenticated printing system.

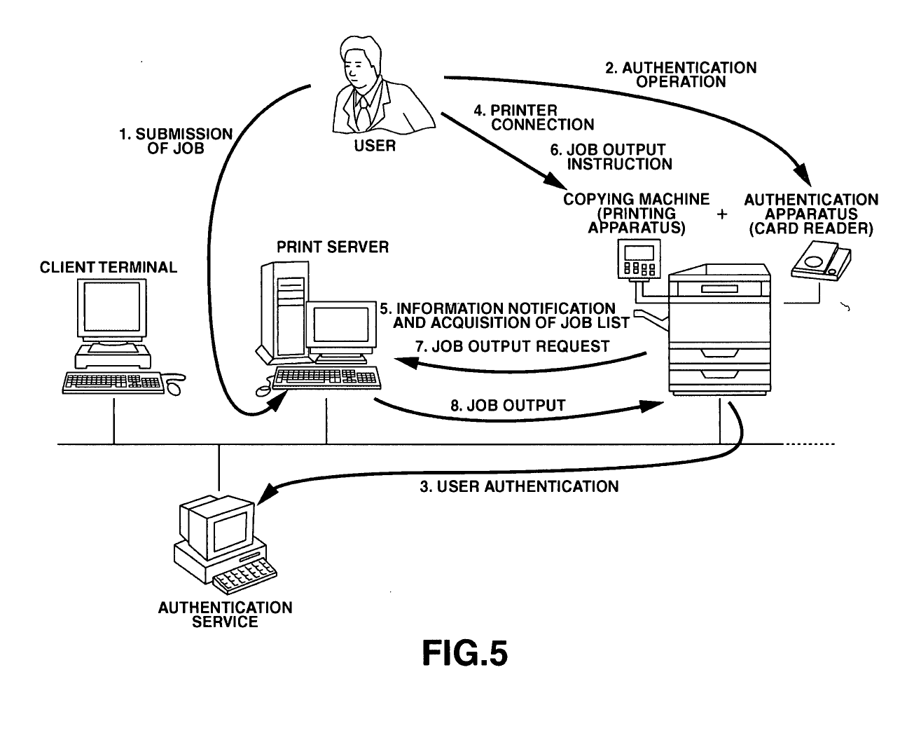

### DETAILED DESCRIPTION

Hereinbelow, an exemplary embodiment of the printing control apparatus, the authenticated printing system, and the recording medium storing a printing control program pertaining to the present invention will be described with reference to the attached drawings.

### Exemplary Embodiment

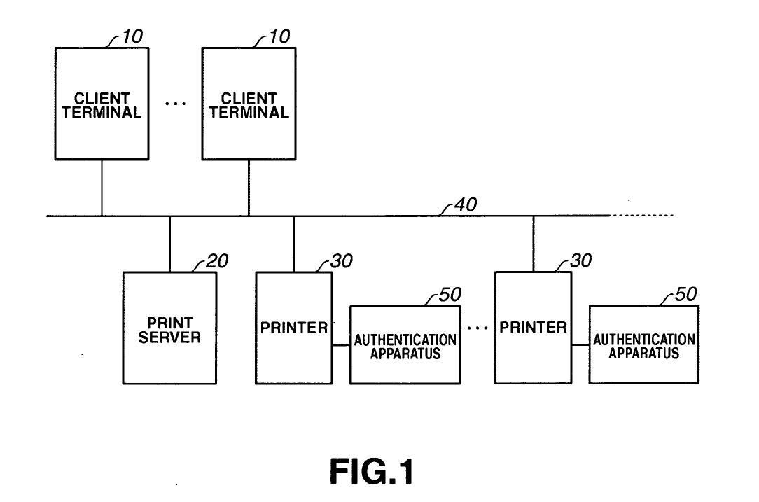

FIG. 1 is a drawing illustrating one example of the entire configuration of the authenticated printing system pertaining to the present invention.

This authenticated printing system is configured to comprise a client terminal 10, a print server 20, and a printer 30, and the respective apparatuses are connected to one another through a network 40, such as a LAN (Local Area Network), or the like.

Herein, the client terminal 10 is a personal computer, or the like, which the user handles, and is provided on the network 40 in a quantity of more than one unit. When the user carries out a prescribed operation for instructing printing from on this client terminal 10, a printing job (a job composed of one or more than one piece of printing data and a series of processing instructions) which is based on this instruction is prepared, and is sent to the print server 20. This printing job is finally sent to the printer 20 for carrying out the printing. In case where printing is instructed from this client terminal 10, there is no need for specifying a particular printer 30, because the printing is carried out from the printer 30 for which authentication has been carried out (the details will be later described).

The print server 20 provides a function of managing and controlling the printing in this authenticated printing system. Specifically, the print server 20 receives a printing job from the client terminal 10; brings the printing job into a printing suspended state for once accumulating and managing it; and transferring the printing job to one of the plurality of printers 30 which are managed by its own apparatus, for implementation of the printing.

The printer 30 is a printing apparatus which receives a printing job sent from the print server 20, and carries out the printing on the basis of the pertinent job, being provided on the network 40 in a quantity of more than one unit. The respective printers 30 are provided with an authentication apparatus 50 associated therewith one to one, and in case where printing is to be carried out by a particular printer 30, this authentication apparatus 50 which is provided for the printer 30, being associated therewith, carries out user authentication about whether the user has printing authority. This authentication is carried out on the basis of inquiry to the internal database of the printer 30 or the authentication apparatus 50, or otherwise to a user management system separately provided.

In the present exemplary embodiment, the case where the authentication apparatus 50 is locally connected to the printer 30 will be taken as an example for description, however, the printer 30 and the authentication apparatus 50 may be connected to each other through the network 40 one to one, or the authentication apparatus 50 may be contained in the printer 30.

In addition, as user authentication with the authentication apparatus 50, the user authentication which utilizes a card-like storage medium carried by the user in which the user identification information (user ID), or the like, is stored (hereinafter called a security card), the user authentication which reads in information about a living-body feature, such as the user's fingerprint, or the like, can be adopted, however, in the present embodiment, the case where a security card is used for carrying out the user authentication will be taken as an example for description.

This security card may be constituted by an IC card which is loaded with an IC (integrated circuit), a magnetic card which has magnetic stripes as recording means, or the like, and in the security card, various types of information necessary for user authentication, such as information about the department with which the user is affiliated, that about the scope of the authority, and the like, are recorded.

Herein, if user authentication is carried out by the authentication apparatus 50, and the authentication is valid, the printing job associated with the pertinent user is sent from the print server 20 to the printer 30 associated with this authentication apparatus 50 for starting the printing. With the printing being started, the print server 20 changes the status of this printing job from printing being suspended to printing being instructed. The user authentication itself may be carried out by the authentication apparatus 50, or may be carried out by the printer 30 or the print server 20 after the authentication apparatus 50 having read out the user identification information.

And, after the job transfer, the printing process in the printer 30 is monitored using the MIB (Management Information Base), or the like. Herein, the printing job for which completion of the output has been verified is cancelled from the print server 20.

In this monitoring in the print server 20, the time count by the timer is started after the job transfer is completed. Herein, in case where there exists a transferred printing job (or printing job) for which completion of the output within a prescribed period of time has not been verified, an output cancel instruction is sent to the printer 30, and the status of the pertinent printing job in the print server 20 is returned from printing being instructed to printing being suspended. This is because there is a possibility that the printer 30 has had a failure, or the like, resulting in the printing being impossible.

In other words, even if the printer has had an error which renders the printing impossible to be continued, the printing job of which output has not been completed will not be deleted from the inside of the print server 20, which eliminates the need for the user returning to the client terminal to again instruct the printing.

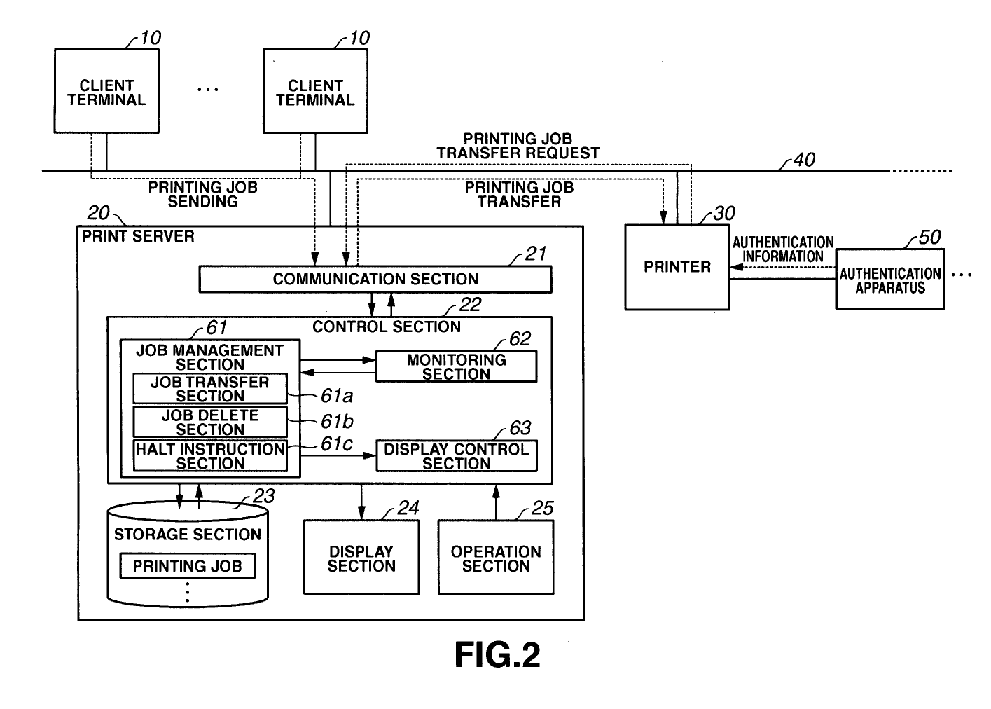

Herein, with reference to FIG. 2, a part of the functional configuration of the print server 20 as shown in FIG. 1 will be described. Here, only the components pertaining to the present invention will be mentioned for description.

The print server 20 is configured to comprise, as the functional configuration thereof, a communication section 21, a control section 22, a storage section 23, a display section 24, and an operation section 25.

The communication section 21 is composed of a network card, and the like, providing the function as the communication interface of controlling the communication between the print server 20 and the network 40. The print server 20 receives a printing job from the client terminal 10 through this communication section 21, and transferred it to the printer 30.

The control section 22 is composed of a CPU (Central Processing Unit), a working memory, and the like, and this CPU reads in the printing control program stored in the storage section 23 using the working memory as a working region for implementation thereof, whereby the printing control process by the present invention is implemented.

The storage section 23 is composed of an HD (Hard Disk), and the like, and provides the function as a storage apparatus for storing various types of data. This storage section 23 stores various types of program, and accumulates and manages a printing job(s) sent from client terminal 10.

The display section 24 is a display apparatus, such as a display, or the like, for carrying out display of various types of information, and the operation section 25 is an input apparatus, such as a keyboard, a mouse, or the like, for inputting a user instruction. Hereinabove, various types of processing function constituting the print server 20 have been described.

Next, a part of the functional configuration of the above-mentioned control section 22 will be described. The various types of process function (function block) which are realized on this control section 22 can be realized mainly by the CPU implementing the printing control program stored in the storage section 23.

The control section 22 is configured to comprise a job management section 61, a monitoring section 62, and a display control section 63 as a section for providing various types of process function.

The job management section 61 provides the function of accumulating and managing a printing job sent from the client terminal 10 in the storage section 23, being configured to comprise a job transfer section 61 a which transfers the printing job associated with the authenticating user to the printer 30 according to the printing job transfer request from the printer 30; a job cancel section 61b which cancels the printing job in the storage section 23 at a prescribed timing; and a halt instruction section 61c which instructs the printer 30 to halt the printing. The cancel timing for this printing job is at the stage of the printing based on that printing job having been completed by the printer 30. In other words, until the printing for the printing job transferred to the printer 30 is completed, the pertinent printing job is held rather than cancelled in the print server 20.

In addition, in order to manage the printing job sent from the client terminal 10 in the printing suspended state, this job management section 61 will not transfer the printing job to the printer 30 immediately after the reception thereof, but according to the printing job transfer request from the printer 30, will transfer the printing job to the printer 30 which is the request sender.

The monitoring section 62 provides the function of monitoring the printing based on the pertinent printing job in the printer 30 after the printing job having been transferred to the printer 30. This monitoring by the monitoring section 62 can be realized with the use of the management information, such as the MIB, or the like, as stated above.

The display control section 63 provides the function of displaying the status indicating the state of the printing job on the display section 24. For example, when the printing job is started to be transferred to the printer 30, the status of the job is changed from printing being suspended to printing being instructed for display.

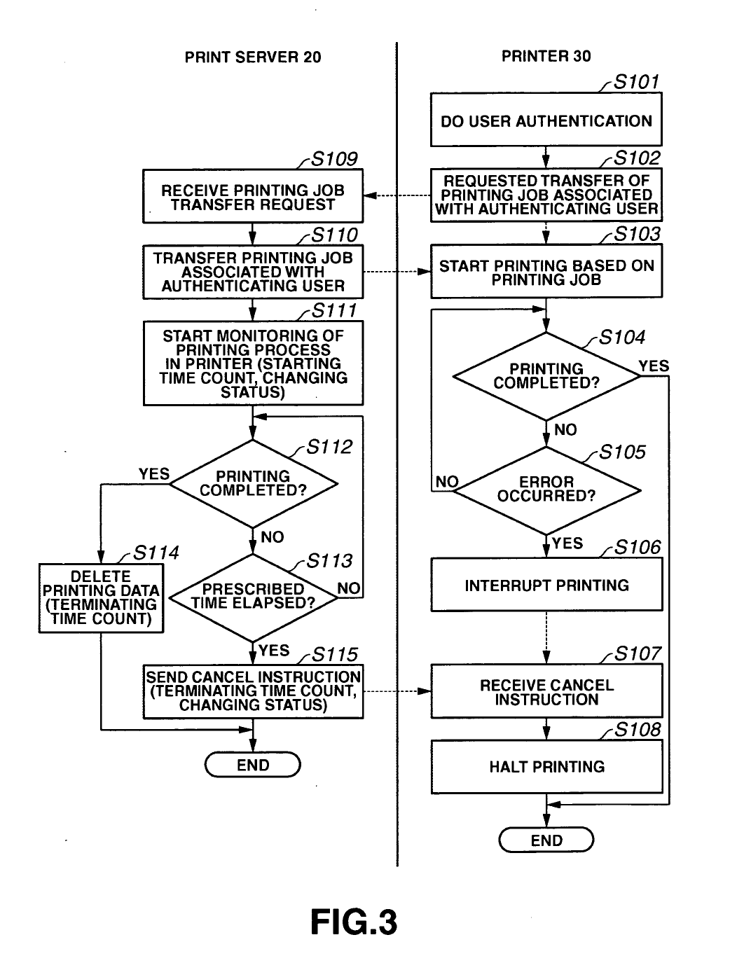

Herein, with reference to FIG. 3, the operation of printing control process in this authenticated printing system as shown in FIG. 1 and FIG. 2 will be described. For convenience of description, it is assumed that one or more than one printing job has been accumulated in the print server 20 for management.

In case where printing is to be carried out with this authenticated printing system, the user who wants printing first carries out user authentication by applying the security card to the authentication apparatus 50 or otherwise doing (at step S101). As a result of this authentication, in case where it has been determined that the pertinent user has the authority to carry out the printing, valid authentication is given, and a transfer request for the printing job is sent from the printer 30 to the print server 20 (at step S102).

When the print server 20 receives this request (at step S109), the job transfer section 61a transfers, to the printer 30, the printing job associated with the user who has carried out this authentication (at step S110). In addition, with the print server 20, the monitoring section 62 starts, after the job transfer, monitoring the printing process in this printer 30 (acquiring the MIB, starting the time count by the timer, and the like) (at step S111), and the display control section 63 changes the status display for the pertinent printing job from printing being suspended to printing being instructed, and displaying it on the display section 24 (at step S111). On the other hand, the printer 30 to which the printing job has been sent starts printing based on this printing job (at step S103).

Herein, in case where the printing by this printer 30 has been completed with no trouble being caused (YES at step S104), the print server 20 is notified thereof, detecting the printing completion (YES at step S112), and terminates monitoring the printer 30. In addition, at this time, with the print server 20, the job cancel section 61b deletes, from the storage section 23, the printing job with which the printing has been completed (at step S114).

In addition, in case where, during the printing process in the printer 30, some error has occurred (YES at step S105), the printer 30 interrupts the printing (at step S106), waiting for recovery. Herein, in case where, with the print server 20, the timer count has reached a prescribed time before the printing by the printer 30 is completed (YES at step S113 after NO at step S112), the halt instruction section 61c instructs the printer 30 to cancel the output (at step S115). In addition, with this action, the job management section 61 returns the pertinent printing job to the printing suspended state, the display control section 63 changing the status display for the pertinent printing job from printing being instructed to printing being suspended, and displaying it on the display section 24. And, this printing process is terminated.

Thus, in case where the printer has had an error which renders the printing impossible to be further continued, the printing is cancelled (halted), and the printing job in the storage section 23 of the print server 20 is returned to the status of printing being suspended, being reset to the state before the printing having been instructed. Therefore, in case where this printing is to be started over again, the need for the user returning to the client terminal 10 to again instruct the printing is eliminated, and the user is required only carrying out authentication again with the authentication apparatus 50 provided in combination with the printer 30.

Hereinabove, one example of the typical embodiment of the present invention has been described, however, the present invention is not limited to the exemplary embodiment as described above and illustrated in the charts, and may be modified within the scope and spirit of the claimed invention in embodiments. Herein, some modifications pertaining to the present invention will be mentioned.

a) As described in the above exemplary embodiment, in case where valid authentication is given, the printing job associated with the authenticating user is transferred to the printer 30, however, the system may be configured such that, in case where a plurality of printing jobs associated with the authenticating user are accumulated on the print server 20 side, all of these plurality of printing jobs associated with the authenticating user are transmitted to the printer 30, or the system may be configured such that, with valid authentication being given, a list of printing jobs which have been permitted to be printed is displayed on the operator panel in the printer 30 for the authenticating user, and from this, the user is caused to select the printing job which the user wants printing, only the selected printing job being transmitted to the printer 30.

b) In the exemplary embodiment as described above, the method for transferring the printing job after receiving a transfer request from the printer 30 has not been described in detail, however, in case where a plurality of printing jobs associated with the authenticating user are managed by the print server 20, they may be transferred as a batch or in small quantities in sequence. However, in such a case as that where large quantities of job are collectively transferred; that the start of printing is delayed due to the preceding printing process; or the like, it takes a long period of time, even if, during the printing process in the printer 30, there occurs no error, or the like, which may result in the timer count having reached a prescribed time, causing malfunctioning.

As measures against this, a first method which sets the timer at a rather long period of time in consideration of the time period required, and a second method which transfers the printing jobs in small quantities, and finely sets the start of time count by the timer for every printing job, and the like, can be mentioned.

c) In the exemplary embodiment as described above, a configuration in which, mainly in case where the timer count has reached a prescribed time, it is determined that the printer 30 has had an error which renders the printing impossible to be further continued is adopted, however, the system may be configured such that, in case where the MIB of the printer 30 has a value which indicates a faulty state, the error in the printer 30 is detected simply by identifying the value without using the timer. In addition, contrarily, the system may be configured such that only the time count by the timer is used as a measure, and in case where, even if a prescribed period of time has elapsed, no printing completion notification is given by the printer 30, it is determined from this that there occurs an error.

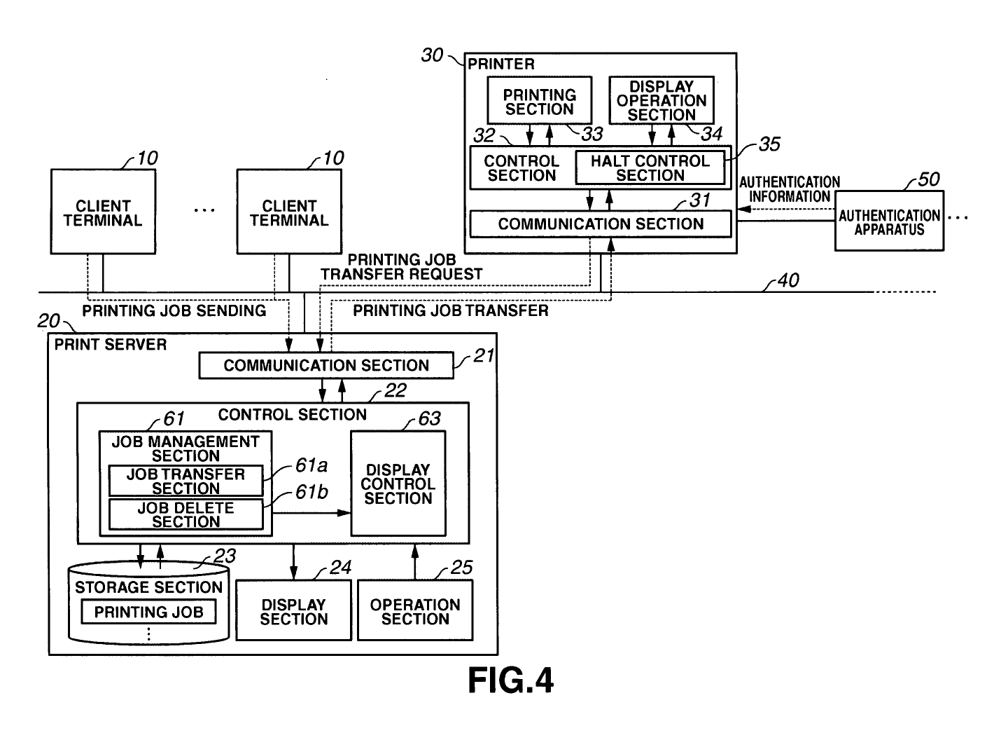

d) The present invention may be implemented by using the notification from the printer 30 rather than by using the MIB or the count timer on the print server 20 side for monitoring the printer 30. For example, this can be realized with the configuration as shown in FIG. 4. In FIG. 4, the same components as those in FIG. 2 above are provided with the same signs. As shown in FIG. 4, with this configuration, monitoring is not carried out in the print server 20 (thus the monitoring section 62 as shown in FIG. 2 is excluded), and if the printer 30 has had an error during the printing process, the halt control section 35 cancels (halts) the printing on the printer 30 side, notifying the print server 20 thereof. And, on the side of the print server 20, which has received this notification, the pertinent printing job is returned to the printing suspended state.

In addition, for example, the system may be configured such that, in case where the printer 30 has had an error during the printing process, a selection screen about whether the printing which is being implemented is to be halted or not is displayed on the operator panel of the printer 30 (the display operation section 34 as shown in FIG. 4) for causing the user to make selection. Herein, in case where cancel is selected, the halt control section 35 of the printer 30 cancels (halts) the printing, notifying the print server 20 thereof, and on the print server 20 side, the printing job associated with this printing is returned to the printing suspended state.

e) The system may be configured such that, in case where the printer 30 has had an error during the printing process, not only the printing job interrupted by that error, but also the printing including the subsequent job(s) are cancelled. As this canceling method, a method which cancels the printing jobs associated with the authenticating user (the job which is being implemented, and the subsequent job(s)) (on a per-user basis), a method which cancels all the printing jobs in the pertinent printer 30 (on a per-system basis), and so on may be mentioned.

f) The system may be configured such that the printer 30 is a printer which comprises a function of distinguishing between an authenticated printing job from the print server 20, and an ordinary printing job sent directly from the client terminal 10 for processing, and in case where the printer 30 has had an error during the printing process, it distinguishes the authenticated printing job transferred from the print server 20 from the ordinary, and cancels the printing, notifying the print server 20 thereof.

g) In the exemplary embodiment as described above, the case where the present invention is implemented by the authenticated printing system pertaining to the present invention has been described, however, this scheme may be adapted such that the process is implemented by a printing control program installed in the computer. This printing control program may, of course, be provided by communication means, such as a network, or the like, and may also be provided, being stored in a recording medium, such as a CD-ROM, or the like.

The printing control apparatus, the authenticated printing system, and the printing control program of the present invention are applicable to a computer for control of printing, and any system containing it, and by applying the present invention, the security and the convenience especially in the event that the printing process is interrupted can be improved.

The foregoing description of the exemplary embodiment of the present invention has been provided for the purpose of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

What is claimed is:

1. A printing control apparatus, comprising:
a storage section that stores a printing job;
a transfer section that transfers the stored printing job to a printing apparatus according to a transfer request based on an authentication, and changes a state of the printing job from a printing suspended state to a printing instructed state;
a monitoring section that monitors a printing process in the printing apparatus for the printing job transferred by the transfer section; and
a printing control section that, in case where the monitoring section detects that the printing process of the transferred printing job in the printing apparatus has been interrupted, instructs the printing apparatus to halt the printing processing, and causes the state of the printing job to be changed from the printing instructed state to the printing suspended state.

2. The printing control apparatus of claim 1, wherein, in case where, after a printing job is transferred by the transfer section, the printing process in the printing apparatus is not completed within a prescribed period of time, the monitoring section determines that the printing process of the printing job has been interrupted.

3. The printing control apparatus of claim 1, wherein, after the transfer section transfers a printing job, the monitoring section acquires management information from the printing apparatus, and on the basis of the management information, determines whether the printing process of the printing job has been interrupted.

4. The printing control apparatus of claim 2, wherein, after the transfer section transfers a printing job, the monitoring section acquires management information from the printing apparatus, and on the basis of the management information, determines whether the printing process of the printing job has been interrupted.

5. The printing control apparatus of claim 1, wherein, in case where it is determined that the printing process in the printing apparatus is interrupted, the printing control section instructs the printing apparatus to halt the printing process of the interrupted printing job of the printing jobs transferred by the transfer section.

6. The printing control apparatus of claim 1, wherein, in case where it is determined that the printing process in the printing apparatus is interrupted, the printing control section instructs the printing apparatus to halt the printing process of all the printing jobs which printing process has not been completed, of the printing jobs transferred by the transfer section.

7. The printing control apparatus of claim 1, further comprising a delete section that, after the printing process in the printing apparatus is completed, deletes the printing job corresponding to the printing process from the storage section.

8. The printing control apparatus of claim 1, further comprising a display control section that displays information indicating the processing state of the printing job on a display.

9. An authenticated printing system, comprising:
a management apparatus that stores printing jobs in a printing suspended state for management; and
a printing apparatus that receives transfer of the printing jobs stored in the management apparatus, and performs a printing process of the printing jobs, wherein
the printing apparatus comprises a transmission section that transmits a transfer request for the printing job pertaining to an authentication to the management apparatus on the basis of the authentication; and
the management apparatus comprises:
a transfer section that, according to the transfer request from the printing apparatus, transfers the pertinent printing job to the printing apparatus;
a monitoring section that monitors a printing processing state in the printing apparatus of the printing job transferred by the transfer section; and
a printing control section that, in case where it is determined by the monitoring section that the printing process of the printing job in the printing apparatus has been interrupted, instructs the printing apparatus to halt the printing process, returns the state of the printing job to the printing suspended state, and deletes the printing job when the printing process is determined to have been completed.

10. An authenticated printing system, comprising:
a management apparatus that stores printing jobs in a printing suspended state for management; and
a printing apparatus that receives transfer of the printing jobs stored in the management apparatus, and performs a printing process of the printing jobs; wherein
the printing apparatus comprises:
a transmission section that transmits a transfer request for the printing job pertaining to an authentication to the management apparatus on the basis of the authentication; and
a halt control section that, in case where it is determined that the printing process of the printing job is interrupted, halts the printing of the printing job and notifies the management apparatus of that effect; and
the management apparatus comprises:
a transfer section that, according to a transfer request from the printing apparatus, transfers the printing job to the printing apparatus; and
a printing control section which, in case where a notification of the printing having been halted is received from the printing apparatus, causes the state of the printing job to be returned to the printing suspended state.

11. A computer-readable recording medium storing a printing control program causing a computer to execute a printing control process, the printing control process comprising:
in accordance with a transfer request based on an authentication, transferring a printing job stored in a memory to a printing apparatus and changing a state of the printing job from a printing suspended state to a printing instructed state;
monitoring a printing processing state of the printing job transferred to the printing apparatus; and
in case where it is determined that the printing process of the printing job by the printing apparatus has been interrupted, instructing the printing apparatus to halt the printing processing, and controlling to return the state of the printing job from the printing instructed state to the printing suspended state.
